(19) United States
(12) Patent Application Publication
(10) Pub. No.: US 2019/0276697 A1
(43) Pub. Date: Sep. 12, 2019

(54) IMPROVED ACRYLIC LIQUID APPLIED SOUND DAMPERS

(71) Applicant: Eastman Chemical Company, Kingsport, TN (US)

(72) Inventors: Linda Siebons, Arnhem (NL); Michael Dean Funderburg, Jr., Gray, TN (US); Joseph Alexander Deloach, Jonesborough, TN (US); Francina Petronella Catharina Wubbe, Vlissingen (NL); Jesus Gabriel Moralez, Kingsport, TN (US)

(73) Assignee: Eastman Chemical Company, Kingsport, TN (US)

(21) Appl. No.: 16/302,206

(22) PCT Filed: May 10, 2017
(86) PCT No.: PCT/US2017/031878

§ 371 Date: Nov. 16, 2018

Related U.S. Application Data
(60) Provisional application No. 62/338,747, filed on May 19, 2016.

(51) Int. Cl. C09D 133/10; C09D 133/08; C08L 93/04; C08L 57/00; C09D 7/63

(52) U.S. Cl. CPC C09D 133/10; C09D 133/08; C08K 5/11; C08L 57/00; C09D 7/63; C08L 93/04

(57) ABSTRACT

Novel water-based acrylic coating compositions which provide superior noise suppression are disclosed. Water-based compositions comprised of acrylic polymer, resins, and/or plasticizer, after curing, provide improved vibration damping to solid substrates. Such substrates include the metal surfaces of passenger and commercial vehicles. Resins and plasticizers which provide superior and unexpectedly high vibration damping are disclosed.

### FIELD OF THE INVENTION

The invention relates to improving vibration damping on a substrate. More specifically, the invention relates to the use of novel acrylic coatings to improve vibration damping on a substrate, such as the inner- and under-body of a vehicle. The invention also relates to novel acrylic coatings comprising resins and plasticizers.

### BACKGROUND OF THE INVENTION

The objective of this invention is to provide improved vibration damping performance to metallic substrates. Examples of such substrates include, but are not limited to, those used for the construction of vehicles. More specifically, the objective of this invention is to provide improved vibration damping within the range of temperatures frequently encountered during driving, namely from −30° to 50° C. and most frequently from −10° C. to 40° C. Another objective of this invention is to provide improved vibration damping within this temperature range across the frequencies audible to humans, particularly in the low frequency range of 10 to 200 Hz as described in “Low Frequency Noise. What we know, what we do not know, and what we would like to know”, Leventhall, Geoff, Journal of Low Frequency Noise, Vibration and Active Control 28, 2, pp. 79-104 (2009).

The reduction of noise, vibration, and harshness (often abbreviated as NVH) to humans is a goal of many industrial processes. Exposure to NVH comes from numerous sources, and can be mitigated by various means. For example, laminated safety glass can be comprised of acoustic interlayers which suppress sound transmission. Applications of such acoustic interlayers can include glass panes in commercial and residential buildings and automotive glazing. Other sources of NVH in vehicles include engine noise, road noise, springs and suspensions, braking, and chassis vibration. Noise suppression techniques include component design to reduce vibration and sound transmission; use of composite materials instead of metals; elastomeric sleeves or guards; nonwoven fabrics; carpet or other materials applied to the vehicle interior; foam; liquid-applied damping formulations; and objects produced from viscoelastic materials, such as bitumen or asphaltic pads. Although effective to varying extents depending on the source of the noise, these techniques suffer from limitations. For example, asphaltic pads cannot easily be placed and conformed to some locations on a vehicle body, require manual application, are subject to embrittlement, and must continue to adhere to the metal substrate in order to be effective. Some materials contribute undesired weight to the vehicle, contrary to weight reduction goals designed to improve fuel mileage. Materials which require high temperature and/or long times to cure can slow production, add cost, and result in higher energy usage.

One mode of NVH is through vibration. Polymeric materials can damp, or reduce oscillations of, a substrate by dissipating the oscillation energy with their viscoelastic behavior. A standard measurement of damping utilizes the Oberst method and apparatus. In this method, a material engineered to confer damping behavior is affixed to a stainless steel bar which has negligible damping itself. The effect of the damping material is deduced from the behavior of the sample bar compared to an untreated reference bar. Damping behavior can also be measured using Dynamic Mechanical Thermal Analysis, or DMTA. In this technique, a sample is exposed to a sinusoidal force, generally over a range of temperatures or frequencies. When heated, the modulus of a viscoelastic polymeric substance varies greatly from the glassy state at low temperatures, through the glass transition to a rubbery state, and finally to a lower viscosity molten state. The ratio of the storage modulus to the loss modulus, a value known as the tan δ, is a measure of the material's ability to damp vibrations. Higher tan δ values signify more effective damping behavior. The DMTA tan δ has been shown to correlate well with the Oberst bar testing.

Water-based Acrylic Liquid Applied Sound Dampers (LASD) are well known in the automotive industry. The ease of application and economy of water-based acrylic coatings make them an appealing solution to the reduction of NVH. Water-based acrylic LASD coatings can provide a reduction of the transmission of vibrations from metallic substrates. If the performance of these existing coatings could be improved, a reduction in weight could be obtained, as the same level of vibration damping could be obtained with a thinner coating layer.

### SUMMARY OF THE INVENTION

The present application discloses an acrylic coating composition comprising:
(a) an acrylic polymer component;
(b) a resin; and
(c) a plasticizer,
wherein the resin is present in the composition from about 0 to about 40 phr relative to the sum total of the acrylic polymer component, and
wherein the plasticizer is present in the composition from about 0 to about 15 phr relative to the sum total of the acrylic polymer component,
wherein the total amount of resin and plasticizer is at least 2 phr relative to the sum total of the acrylic polymer component.

The present application also discloses methods of improving vibration damping of a substrate comprising affixing the acrylic coating composition onto a substrate.

### DETAILED DESCRIPTION OF THE INVENTION

As used herein the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein the term “chosen from” when used with “and” or “or” have the following meanings: A variable chosen from A, B and C means that the variable can be A alone, B alone, or C alone. A variable A, B, or C means that the variable can be A alone, B alone, C alone, A and B in combination, A and C in combination, or A, B, and C in combination.

The term “affixing”, as used herein, refers to providing continuous and intimate contact between the composition and the substrate such that the dried composition (acrylic coating) remains on the substrate. For example, an acrylic coating can be affixed to a car inner- or under-body via spray coating the composition onto a car inner- or under-body and subjecting the coated car inner- or under-body to conditions to dry the composition. The term “adhering” as used herein, refers to using an adhesive to affix an acrylic coating in the form of a sheet to a substrate.

The term “composition,” as used herein, refers to either a liquid dispersion of polymeric particles, optionally with other ingredients, or the solid acrylic coating. The liquid dispersion can be an aqueous dispersion. The term “dried composition and”, as used herein, refers to the solid acrylic coating that is formed upon drying the composition and subsequently cooling to a desired temperature. The term “drying”, as used herein, refers to heating of the composition to a temperature sufficient to yield a solid structure with mechanical integrity.

The term “resin,” as used herein, means a natural or semi-synthetic substance derived from plant secretions, or a synthetic or semi-synthetic substance that has similar properties to natural resins. The term “resin” when used in conjunction with “parts per hundred parts” has a different meaning. The term “resin” in this case is the acrylic polymer component, expressed on a 100% solids basis. The amount of plasticizer, resin, or any other component in the acrylic coating composition disclosed herein, can be measured as parts per hundred parts resin (phr), on a weight per weight basis. For example, if 30 grams of plasticizer is added to 100 grams of the acrylic polymer component, then the plasticizer content of the resulting acrylic coating composition would be 30 phr.

The term “rosin”, as used herein, is a mixture of eight closely related rosin acids characterized by three fused six-carbon rings, double bonds that vary in number and location, and a single carboxylic acid group. Three sources of rosin are used for resin manufacture, gum rosin, wood rosin and tall oil rosin, all generated from the pine tree. The term “rosin ester resin”, as used herein, refers to the manufactured product made by reacting rosin with an alcohol.

The term “softening point”, as used herein, refers to the temperature at which a material softens as determined by a ring and ball method such as ASTM E28 or ISO 4625.

The term “substrate”, as used herein, refers to the material that provides the surface onto which the composition is affixed. In one embodiment, the material providing the substrate is the material that transfers the sound or vibration energy. In one embodiment, the substrate is a metal surface.

### Composition

The present application discloses an acrylic coating composition comprising: (a) an acrylic polymer component; (b) a resin; and (c) a plasticizer, wherein the resin is present in the composition from about 0 to about 40 phr relative to the sum total of the acrylic polymer component, and wherein the plasticizer is present in the composition from about 0 to about 15 phr relative to the sum total of the acrylic polymer component, wherein the total amount of resin and plasticizer is at least 2 phr relative to the sum total of the acrylic polymer component.

In one embodiment, the plasticizer is present in the composition at 0 phr relative to the sum total of the acrylic polymer component; and the resin is present in the composition from about 2 to about 40 phr.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the resin is present in the composition from about 2 to about 10 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 10 to about 20 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 20 to about 40 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one embodiment, the plasticizer is present in the composition from about 2 to 10 phr relative to the sum total of the acrylic polymer component; and the resin is present in the composition at 0 phr.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the plasticizer is chosen from terephthalates, benzoates, or glycerol esters. In one class of this embodiment, the plasticizer is chosen from diethylene glycol dibenzoate, dipropylene glycol dibenzoate, triethylene glycol dibenzoate, bis-n-butyl terephthalate, or 1,2,3-triacetoxypropane.

In one class of this embodiment, the plasticizer is present in the composition from about 2 to about 5 phr. In one subclass of this class, the plasticizer is chosen from terephthalates, benzoates, or glycerol esters. In one subclass of this class, the plasticizer is chosen from diethylene glycol dibenzoate, dipropylene glycol dibenzoate, triethylene glycol dibenzoate, bis-n-butyl terephthalate, or 1,2,3-triacetoxypropane.

In one class of this embodiment, the plasticizer is present in the composition from about 5 to about 10 phr. In one subclass of this class, the plasticizer is chosen from terephthalates, benzoates, or glycerol esters. In one subclass of this class, the plasticizer is chosen from diethylene glycol dibenzoate, dipropylene glycol dibenzoate, triethylene glycol dibenzoate, bis-n-butyl terephthalate, or 1,2,3-triacetoxypropane.

In one embodiment, the plasticizer is present in the composition from about 1 to about 5 phr relative to the sum total of the acrylic polymer component.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the plasticizer is chosen from terephthalates, benzoates, or glycerol esters. In one class of this embodiment, the plasticizer is chosen from diethylene glycol dibenzoate, dipropylene glycol dibenzoate, triethylene glycol dibenzoate, bis-n-butyl terephthalate, or 1,2,3-triacetoxypropane.

In one class of this embodiment, the resin is present in the composition at less than about 20 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition at less than about 15 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition at less than about 10 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 1 to about 20 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 1 to about 15 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 1 to about 10 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one embodiment, the plasticizer is present in the composition from about 5 to about 10 phr relative to the sum total of the acrylic polymer component.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the plasticizer is chosen from terephthalates, benzoates, or glycerol esters. In one class of this embodiment, the plasticizer is chosen from diethylene glycol dibenzoate, dipropylene glycol dibenzoate, triethylene glycol dibenzoate, bis-n-butyl terephthalate, or 1,2,3-triacetoxypropane.

In one class of this embodiment, the resin is present in the composition at less than about 20 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition at less than about 15 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition at less than about 10 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 1 to about 20 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 1 to about 10 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one embodiment, the plasticizer is present in the composition from about 10 to about 15 phr relative to the sum total of the acrylic polymer component.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the plasticizer is chosen from terephthalates, benzoates, or glycerol esters. In one class of this embodiment, the plasticizer is chosen from diethylene glycol dibenzoate, dipropylene glycol dibenzoate, triethylene glycol dibenzoate, bis-n-butyl terephthalate, or 1,2,3-triacetoxypropane.

In one class of this embodiment, the resin is present in the composition at less than about 20 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition at less than about 15 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition at less than about 10 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 1 to about 20 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 1 to about 15 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one class of this embodiment, the resin is present in the composition from about 1 to about 10 phr. In one subclass of this class, the resin comprises unhydrogenated or hydrogenated rosin esters, unhydrogenated or hydrogenated rosin acids, aromatic modified hydrocarbon resins, or aliphatic hydrocarbon resins; and the plasticizer is chosen from terephthalates, benzoates, or glycerol esters.

In one embodiment, the resin is present in the composition from about 1 to 20 phr relative to the sum total of the acrylic polymer component.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the resin comprises unhydrogenated or hydrogenated rosin esters, unhydrogenated or hydrogenated rosin acids, an aromatic modified hydrocarbon resins, or aliphatic hydrocarbon resins. In one class of this embodiment, the resin comprises rosin glycerol esters, hydrogenated rosin pentaerythritol esters, or aromatic-modified C5 hydrocarbon resins.

In one embodiment, the resin is present in the composition from about 1 to 15 phr relative to the sum total of the acrylic polymer component.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the resin comprises unhydrogenated or hydrogenated rosin esters, unhydrogenated or hydrogenated rosin acids, an aromatic modified hydrocarbon resins, or aliphatic hydrocarbon resins. In one class of this embodiment, the resin comprises rosin glycerol esters, hydrogenated rosin pentaerythritol esters, or aromatic-modified C5 hydrocarbon resins.

In one embodiment, the resin is present in the composition from about 1 to 10 phr relative to the sum total of the acrylic polymer component.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the resin comprises unhydrogenated or hydrogenated rosin esters, unhydrogenated or hydrogenated rosin acids, an aromatic modified hydrocarbon resins, or aliphatic hydrocarbon resins. In one class of this embodiment, the resin comprises rosin glycerol esters, hydrogenated rosin pentaerythritol esters, or aromatic-modified C5 hydrocarbon resins.

In one embodiment, the resin is present in the composition from about 20 to 40 phr relative to the sum total of the acrylic polymer component.

In one class of this embodiment, the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

In one class of this embodiment, the resin comprises unhydrogenated or hydrogenated rosin esters, unhydrogenated or hydrogenated rosin acids, aromatic modified hydrocarbon resins, or aliphatic hydrocarbon resins. In one class of this embodiment, the resin comprises rosin glycerol esters, hydrogenated rosin pentaerythritol esters, or aromatic-modified C5 hydrocarbon resins.

In one embodiment, the resin has a softening point in the range of from about 60° C. to about 100° C. In one embodiment, the resin has a softening point in the range of from about ranges from 65° C. to 95° C.

In one embodiment, the resin comprises unhydrogenated or hydrogenated rosin esters, unhydrogenated or hydrogenated rosin acids, aromatic modified hydrocarbon resins, or aliphatic hydrocarbon resins.

In one class of this embodiment, the resin has a softening point in the range of from about 60° C. to about 100° C. In one class of this embodiment, the resin has a softening point in the range of from about ranges from 65° C. to 95° C.

In one class of this embodiment, the resin comprises unhydrogenated rosin esters. In one class of this embodiment, the resin comprises hydrogenated rosin esters. In one class of this embodiment, the resin comprises unhydrogenated rosin acids. In one class of this embodiment, the resin comprises hydrogenated rosin acids. In one class of this embodiment, the resin comprises aromatic modified hydrocarbon resins. In one class of this embodiment, the resin comprises aliphatic hydrocarbon resins.

In one class of this embodiment, the resin comprises rosin glycerol esters, hydrogenated rosin pentaerythritol esters, or aromatic-modified C5 hydrocarbon resins. In one subclass of this class, the resin has a softening point in the range of from about 60° C. to about 100° C. In one subclass of this class, the resin has a softening point in the range of from about ranges from 65° C. to 95° C.

In one class of this embodiment, the resin comprises rosin glycerol esters. In one class of this embodiment, the resin comprises hydrogenated rosin pentaerythritol esters. In one class of this embodiment, the resin comprises aromatic-modified C5 hydrocarbon resins.

In one class of this embodiment, the resin is a water-based dispersion comprising rosin esters or aromatic-modified hydrocarbon resins. In one subclass of this class, the resin has a softening point in the range of from about 60° C. to about 100° C. In one subclass of this class, the resin has a softening point in the range of from about ranges from 65° C. to 95° C.

The plasticizer component is not particularly limited. In one embodiment, the plasticizer is chosen from orthophthalates; terephthalates; isophthalates; trimellitates; adipates; cyclohexanedicarboxylates; benzoates; phosphates; diesters of ethylene glycol, propylene glycol, their oligomers, or mixtures thereof; citrates; succinates; alkyl sulfonates; fatty acid esters and epoxidized fatty acid esters, optionally substituted; triglycerides and epoxidized triglycerides, optionally substituted; dianhydrohexitol diesters; pentaerythritol-based tetraesters; furan-based esters; glycerol esters; or polymeric plasticizers. In one class of embodiment, the plasticizer is chosen from terephthalates, benzoates, or glycerol esters. In one class of this embodiment, the plasticizer is chosen from diethylene glycol dibenzoate, dipropylene glycol dibenzoate, triethylene glycerol dibenzoate, bis-n-butyl terephthalate, or 1,2,3-triacetoxypropane.

The acrylic polymer component is not particularly limited. In one embodiment, the acrylic polymer component is derived from an (C₁₋₈)alkyl acrylate, (C₁₋₈)alkyl methacrylates, or mixtures of the two. In one class of this embodiment, the acrylic polymer component is derived from an (C₁₋₄)alkyl acrylates, an (C₁₋₄)alkyl methacrylates, or mixtures of the two. In one class of this embodiment, the acrylic polymer component is derived from an (C₁₋₈)alkyl acrylate. In one class of this embodiment, the acrylic polymer component is derived from an (C₁₋₈)alkyl methacrylate. In one class of this embodiment, the acrylic polymer component is derived from a mixture of an (C₁₋₈)alkyl acrylate and an (C₁₋₈)alkyl methacrylate. In one class of this embodiment, the acrylic polymer component is derived from an (C₁₋₄)alkyl acrylate. In one class of this embodiment, the acrylic polymer component is derived from an (C₁₋₄)alkyl methacrylate. In one class of this embodiment, the acrylic polymer component is derived from a mixture of an (C₁₋₄)alkyl acrylate and an (C₁₋₄)alkyl methacrylate.

Other copolymerizable monomers can be included in the acrylic polymer. Such monomers include but are not limited to styrene. In one class of this embodiment, the acrylic polymer component comprises 3 a methacrylic ester-acrylic ester copolymer, or an acrylic ester-styrene copolymer. Other polymeric components optionally can be blended into the acrylic emulsion.

In one embodiment of the acrylic coating composition, the acrylic coating composition further comprises other components. In one class of this embodiment, other components are chosen from fillers, pigments, stabilizers, foaming agents, hollow materials, surfactants, coalescing aids, defoamers, biocides, rheology control additives, or adhesion promoters. In one subclass of this class, the other components are present in the range of 5 to 250 phr relative to the sum total of the acrylic polymer component. In one subclass of this class, the other components are present in the range of 5 to 50 phr relative to the sum total of the acrylic polymer component. In one subclass of this class, the other components are present in the range of 50 to 100 phr relative to the sum total of the acrylic polymer component. In one subclass of this class, the other components are present in the range of 100 to 150 phr relative to the sum total of the acrylic polymer component. In one subclass of this class, the other components are present in the range of 150 to 250 phr relative to the sum total of the acrylic polymer component.

In one embodiment, the acrylic coating compositions further comprises fillers. In one class of this embodiment, the filler is inorganic. In one class of this embodiment, the fillers can represent between 5 wt % and 70 wt % by weight. In one class of this embodiment, the fillers can represent between 10 wt % and 60 wt %. In one class of this embodiment, the fillers can represent between 5 to 250 phr relative to the sum total of the acrylic polymer component. In one class of this embodiment, the fillers can represent between 5 to 50 phr relative to the sum total of the acrylic polymer component. In one class of this embodiment, the fillers can represent between 50 to 100 phr relative to the sum total of the acrylic polymer component. In one embodiment, the fillers can represent between 100 to 150 phr relative to the sum total of the acrylic polymer component. In one class of this embodiment, the fillers can represent between 150 to 250 phr relative to the sum total of the acrylic polymer component. Suitable fillers include but are not limited to calcium carbonate, magnesium carbonate, silica, clay, mica, graphite, and/or zinc oxide. Pigments can be incorporated into the inventive compositions to achieve desired visual effects, as known to those skilled in the art.

In one embodiment, the acrylic composition can be formulated or produced in a manner which incorporates more free volume into the cured coating. In one such technique, mechanical frothing can be applied to produce a foamed composition. In one embodiment, a chemical foaming agent which results in a foamed structure after curing is incorporated. One non-limiting example of such a foaming agent is azodicarbonamide. Other examples of foaming agents include isocyanates, sodium carbonate, sodium bicarbonate, 5-hydroxytetrazole, p-phenylene-bis(5-tetrazole), 5-methyltetrazole, 5-phenyltetrazole, and 5-(benzyl)-tetrazole, 5-(p-toluyl)-tetrazole, and sodium borohydride. In one embodiment, a catalyst is used along with the chemical foaming agent. In other one embodiment, foam stabilizers are used. In embodiment, hollow materials are incorporated into the formulation. Such materials include glass beads, microbeads, and microspheres, which can be produced from either inorganic or polymeric organic substances. In one embodiment, the hollow materials are thermoplastic microspheres.

In one embodiment, additives to control rheology can be incorporated into the inventive water-based acrylic composition. Thickeners can be added to boost viscosity as desired. Materials and techniques for adjusting acrylic rheology are well known to those skilled in the art.

In one embodiment, adhesion promoters can be incorporated into the acrylic composition. Suitable adhesion promoters include but are not limited to polyamidoamines, blocked isocyanates and isocyanurates, and silanes.

In on embodiment, formulation aids can be incorporated, such as, surfactants, defoamers, biocides, coalescing aids, as known to those skilled in the art

In one embodiment, the dried composition has a maximum Tan Delta (Tan δₘₐₓ) occurring between −20° C. and 70° C. and the Tan δₘₐₓ ranges from 1.0 to 5.0, when measured on a circular sample of 8 mm diameter and nominally 1-2 mm thickness using a Dynamic Mechanical Analyzer with 8 mm stainless steel plates at an automatic strain adjustment from 0.1% to 15% and at a frequency of 1 Hz and a temperature ramp rate of 5° C./min.

In one embodiment, the dried composition has a maximum Tan Delta (Tan δₘₐₓ) occurring between 10° C. and 40° C. and the Tan δₘₐₓ ranges from 1.0 to 5.0, when measured on a circular sample of 8 mm diameter and nominally 1-2 mm thickness using a Dynamic Mechanical Analyzer with 8 mm stainless steel plates at an automatic strain adjustment from 0.1% to 15% and at a frequency of 1 Hz and a temperature ramp rate of 5° C./min.

### Method of Improving Vibration

The present application discloses a method of improving vibration damping of a substrate comprising affixing an acrylic coating composition onto the substrate, wherein the acrylic coating composition comprises: (a) an acrylic polymer component; (b) a resin; and (c) a plasticizer, wherein the resin is present in the composition from about 0 to about 40 phr relative to the sum total of the acrylic polymer component, and wherein the plasticizer is present in the composition from about 0 to about 15 phr relative to the sum total of the acrylic polymer component, wherein the total amount of resin and plasticizer is at least 2 phr relative to the sum total of the acrylic polymer component. The acrylic coating composition can have any combination of the attributes described herein above.

The substrate is not particularly limited. In one embodiment, the substrate is a metal. In one embodiment, the substrate comprises steel. In one embodiment, the substrate comprises aluminum. In one embodiment, the substrate is part of a wheeled vehicle. In one embodiment, the substrate is on the under-body of a wheeled vehicle. In one embodiment, the substrate is on the inner-body of a wheeled vehicle. In one embodiment, the substrate is a wood or a ceramic.

In one embodiment, the method of affixing the composition onto the substrate comprises (a) applying the composition onto the substrate, (b) drying the composition to produce an acrylic-coated substrate, and (c) cooling the acrylic-coated substrate to ambient temperatures.

In one class of this embodiment, the substrate is metal. In one class of this embodiment, the substrate comprises steel. In one class of this embodiment, the substrate comprises aluminum. In one class of this embodiment, the substrate is part of a wheeled vehicle. In one class of this embodiment the substrate is on the under-body of a wheeled vehicle. In one class of this embodiment the substrate is on the inner-body of a wheeled vehicle. In one class of this embodiment, the substrate is wood or ceramic.

In one class of this embodiment, the drying occurs at a temperature range from 20° C. to 220° C. for a time period ranging from 1 minute to 24 hours. In one subclass of this class, the substrate is metal. In one subclass of this class, the substrate comprises steel. In one subclass of this class, the substrate comprises aluminum. In one subclass of this class, the substrate is part of a wheeled vehicle. In one subclass of this class, the substrate is on the under-body of a wheeled vehicle. In one subclass of this class, the substrate is on the inner-body of a wheeled vehicle. In one subclass of this class, the substrate is wood or ceramic.

In one class of this embodiment, the drying occurs at a temperature range from 20° C. to 175° C. for a time period ranging from 1 minute to 24 hours. In one subclass of this class, the substrate is metal. In one subclass of this class, the substrate comprises steel. In one subclass of this class, the substrate comprises aluminum. In one subclass of this class, the substrate is part of a wheeled vehicle. In one subclass of this class, the substrate is on the under-body of a wheeled vehicle. In one subclass of this class, the substrate is on the inner-body of a wheeled vehicle. In one subclass of this class, the substrate is wood or ceramic.

In one class of this embodiment, the drying occurs at a temperature range from 100° C. to 175° C. for a time period ranging from 1 minute to 24 hours. In one subclass of this class, the substrate is metal. In one subclass of this class, the substrate comprises steel. In one subclass of this class, the substrate comprises aluminum. In one subclass of this class, the substrate is part of a wheeled vehicle. In one subclass of this class, the substrate is on the under-body of a wheeled vehicle. In one subclass of this class, the substrate is on the inner-body of a wheeled vehicle. In one subclass of this class, the substrate is wood or ceramic.

The method for applying the composition onto the substrate is not particularly limited. In one class of this embodiment, applying the composition onto the substrate comprises coating the substrate with the composition. Non-limiting examples of coating include spray coating and/or extrusion coating. In one subclass of this class, the drying occurs at a temperature range from 20° C. to 220° C. for a time period ranging from 1 minute to 24 hours.

In one class of this embodiment, the method of affixing the composition to the substrate comprises (a) drying the composition into a sheet and (b) adhering the sheet to the substrate. In one subclass of this class, the drying occurs at a temperature range from 20° C. to 175° C. for a time period ranging from 1 minute to 24 hours.

The acrylic-coated substrate comprises the substrate and the acrylic coating made up of the dried composition. In one embodiment, the acrylic coating on the substrate has a thickness in the range of from about 1 mm to about 6 mm. In one embodiment, the coating on the substrate has a thickness in the range of from about 1 mm to about 3 mm.

In one embodiment, the acrylic coating on the substrate has a mass in the range of from about 1 kg/m² to about 3 kg/m². In one embodiment, the acrylic coating on the substrate has a mass in the range of from about 2 kg/m² to about 3 kg/m². In one embodiment, the acrylic coating on the substrate has a mass that is less than 3 kg/m².

### Examples

### Abbreviations

Pz is plasticizer; g is gram; ° C. is degrees Celsius; Ex is example; Comp. Ex is comparative example; mm is millimeter; d is day(s); DMTA is dynamic mechanical thermal analysis; Hz is Hertz; Temp is temperature; phr is parts per hundred resin; rt is room temperature; Benzoflex™ 2088 Plasticizer (benzoate esters), Eastman Effusion™ Plasticizer (dibutyl terephthalate), and Eastman™ Triacetin Plasticizer (1,2,3-propanetriol triacetate) are commercially available (Eastman Chemical Company, Kingsport, Tenn.) and were used without further processing. The resin dispersions listed in Table 1 are commercially available (Eastman Chemical Company, Kingsport, Tenn.) and were used without further processing. The acrylic resin dispersions listed in Table 2 were used without further processing.

The resins, plasticizers, and acrylics used in the examples are listed in Table 1(a)-1(c).

TABLE 1(a)
Resins used in Examples

| | | Softening | |
|---|---|---|---|
| Resin ID | Chemical type | point, ° C. | Trade names |
| Resin R1 | Glycerol ester of rosin | 71 | Tacolyn ™ 3179H resin |
| | | | dispersion |
| Resin R2 | Hydrogenated | 92 | Tacolyn ™ 3100 resin |
| | pentaerytritol ester of | | dispersion |
| | rosin | | |
| Resin R3 | Aromatic-modified C5 | 70 | Tacolyn ™ 1070 resin |
| | hydrocarbon resin | | dispersion |
| Resin R4 | C5 hydrocarbon resin | 70 | Tacolyn ™ 5070 resin |
| | | | dispersion |

TABLE 1(b)
Plasticizers used in Examples

| Plasticizer | | |
|---|---|---|
| ID | Chemical type | Trade Names |
| Pz 1 | Benzoate Esters | Benzoflex ™ 2088 Plasticizer |
| Pz 2 | bis-n-butyl terephthalate | Eastman Effusion ™ Plasticizer |
| Pz 3 | 1,2,3-propanetriol triacetate | Eastman ™ Triacitin Plasticizer |

TABLE 1(C)
Acrylics used in Examples

| Acrylic ID | Chemical type | Trade names | Supplier |
|---|---|---|---|
| Acrylic 1 | methacrylic ester-acrylic | Acousticryl ™ | Dow Chemical |
| | ester copolymer | AV-2240 | Company |
| Acrylic 2 | acrylic ester-styrene | Revacryl ™ | Synthomer |
| | copolymer | AE3723 | |
| Acrylic 3 | acrylic ester-styrene | Revacryl ™ | Synthomer |
| | copolymer | AE6030 | |

### General Preparation of Acrylic Formulations and Samples for DMTA Evaluation

To a mixing cup was added 0-2 g of plasticizer. To this 25 g of acrylic emulsion was slowly added, while stirring continuously. Then 0-11 g of resin dispersion was added to the mixing cup, and the formulation was mixed so that a homogeneous mixture was obtained. Based on the solids content of the acrylic emulsion and the solids content of the resin dispersion, the correct required weight of resin dispersion was calculated to obtain the specified phr of resin.

Samples for DMTA analysis were prepared by casting the acrylic formulation into a silicone coated mold, in a wet layer thickness of 2-4 mm, resulting in a dry layer thickness of 1-2 mm. The filled molds were placed in an air circulation oven at 35° C. for 3 d to cure, unless otherwise specified. From the cured film, samples of 8 mm diameter were cut using a hollow punch tool.

DMTA measurements were performed on these samples using an 8 mm steel parallel plate fixture on an ARES-G2 rheometer from TA Instruments. Storage modulus, loss modulus, and tan delta (tan δ) results were recorded at a frequency of 1 Hz, during heating of the sample from −50° C. to 80° C. at a heating rate of 5° C./min. Automatic strain adjustment, from 0.1% to 15%, was used to stay within the limits of the rheometer transducer and the linear viscoelastic range of the sample for the full temperature range.

### Examples 1-7 and Comparative Examples C1

Ex 1-7 were made according to the general procedure without any plasticizer and with Acrylic 1 and the specific resin as shown in Table 2. The weights of the components are displayed as parts by weight of the acrylic solids. Comp Ex C1 was made according to the general procedure using Acrylic 1 without any plasticizer or resin.

The results show that the Comp Ex C1 can provide a maximum tan δ peak in the temperature range of interest (0-40° C.). However, blending the same acrylic with Resin R1, Resin R2, or Resin R3, provides the tan δ peak to be higher. A higher resin concentration results in a higher tan δ peak. The resin slightly shifts the tan δ peak to a higher temperature for Resin R2 and Resin R3. Resin R4 does not change the height or position of the tan δ peak.

TABLE 2
Acrylic 1, Resins R1-R4, and No Plasticizer.

| | Temp | Comp | | | | | | | |
|---|---|---|---|---|---|---|---|---|---|
| | (° C.) | Ex C1 | Ex 1 | Ex 2 | Ex 3 | Ex 4 | Ex 5 | Ex 6 | Ex 7 |
| Resin (phr) | | | R1 (5) | R1 (40) | R2 (5) | R2 (40) | R3 (5) | R3 (40) | R4 (20) |
| Acrylic 1 (phr) | | 100 | 100 | 100 | 100 | 100 | 100 | 100 | 100 |
| | | Tan δ | | | | | | | |
| | −50 | 0.06 | 0.05 | 0.04 | 0.05 | 0.06 | 0.05 | 0.05 | 0.05 |
| | −40 | 0.07 | 0.06 | 0.04 | 0.06 | 0.08 | 0.06 | 0.06 | 0.06 |
| | −30 | 0.08 | 0.07 | 0.05 | 0.07 | 0.09 | 0.07 | 0.08 | 0.08 |
| | −20 | 0.13 | 0.12 | 0.08 | 0.11 | 0.11 | 0.11 | 0.10 | 0.14 |
| | −10 | 0.29 | 0.27 | 0.16 | 0.24 | 0.16 | 0.26 | 0.17 | 0.33 |
| | 0 | 0.39 | 0.42 | 0.46 | 0.41 | 0.33 | 0.41 | 0.42 | 0.48 |
| | 10 | 0.56 | 0.57 | 0.83 | 0.54 | 0.67 | 0.53 | 0.71 | 0.62 |
| | 20 | 1.21 | 1.23 | 1.59 | 1.15 | 1.08 | 1.15 | 1.23 | 1.22 |
| | 25 | 1.56 | 1.61 | 1.96 | 1.58 | 1.54 | 1.59 | 1.82 | 1.57 |
| | 30 | 1.50 | 1.53 | 1.73 | 1.59 | 1.83 | 1.59 | 1.91 | 1.54 |
| | 40 | 1.09 | 1.09 | 1.23 | 1.13 | 1.40 | 1.13 | 1.34 | 1.17 |
| | 50 | 0.94 | 0.96 | 1.17 | 0.97 | 1.21 | 0.97 | 1.16 | 1.07 |
| | 60 | 0.98 | 1.01 | 1.35 | 1.01 | 1.29 | 1.00 | 1.24 | 1.17 |
| | 70 | 1.14 | 1.19 | 1.72 | 1.18 | 1.56 | 1.16 | 1.46 | 1.37 |
| | 80 | 1.37 | 1.40 | 2.26 | 1.39 | 1.96 | 1.36 | 1.79 | 1.50 |

### Examples 8-14 and Comparative Examples C2

Ex 8-14 were made according to the general procedure without any plasticizer and with Acrylic 2 and the specific resin as shown in Table 3. The weights of the components are displayed as parts by weight of the acrylic solids. Comp Ex C2 was made according to the general procedure using Acrylic 2 without any plasticizer or resin.

The results show that the Comp Ex C2 can provide a maximum tan δ peak in the temperature range of interest (0-40° C.). However, blending the same acrylic with Resin R1, Resin R2, or Resin R3, provides the tan δ peak to be higher. A higher resin concentration results in a higher tan δ peak. The resin slightly shifts the tan δ peak to a higher temperature for Resin R2 and Resin R3. Resin R4 does not increase the tan δ peak height.

TABLE 3
Acrylic 2, Resin R1-R4, and No Plasticizer

| | Temp | Comp | | | | | | | |
|---|---|---|---|---|---|---|---|---|---|
| | (° C.) | Ex C2 | Ex 8 | Ex 9 | Ex 10 | Ex 11 | Ex 12 | Ex 13 | Ex 14 |
| Resin (phr) | | | R1 (5) | R1 (40) | R2 (5) | R2 (40) | R3 (5) | R3 (40) | R4 (20) |
| Acrylic 2 (phr) | | 100 | 100 | 100 | 100 | 100 | 100 | 100 | 100 |
| | | tan δ | | | | | | | |
| | −40 | 0.04 | 0.04 | 0.03 | 0.04 | 0.04 | 0.04 | 0.04 | 0.04 |
| | −30 | 0.05 | 0.05 | 0.04 | 0.04 | 0.04 | 0.05 | 0.04 | 0.04 |
| | −20 | 0.06 | 0.06 | 0.05 | 0.06 | 0.05 | 0.06 | 0.05 | 0.06 |
| | −10 | 0.09 | 0.09 | 0.08 | 0.09 | 0.07 | 0.08 | 0.08 | 0.09 |
| | 0 | 0.19 | 0.19 | 0.18 | 0.18 | 0.11 | 0.16 | 0.13 | 0.19 |
| | 10 | 0.81 | 0.71 | 0.59 | 0.60 | 0.23 | 0.83 | 0.41 | 0.85 |
| | 20 | 2.38 | 2.42 | 3.03 | 2.45 | 1.09 | 2.46 | 2.15 | 1.63 |
| | 25 | 1.69 | 1.65 | 2.41 | 1.77 | 2.11 | 1.74 | 2.77 | 1.21 |
| | 30 | 1.13 | 1.11 | 1.55 | 1.34 | 2.69 | 1.17 | 1.98 | 0.91 |
| | 40 | 0.60 | 0.60 | 0.78 | 0.69 | 1.38 | 0.62 | 0.97 | 0.63 |
| | 50 | 0.35 | 0.35 | 0.46 | 0.39 | 0.74 | 0.36 | 0.55 | 0.51 |
| | 60 | 0.25 | 0.25 | 0.33 | 0.27 | 0.44 | 0.26 | 0.35 | 0.46 |
| | 70 | 0.22 | 0.23 | 0.31 | 0.23 | 0.32 | 0.23 | 0.29 | 0.44 |
| | 80 | 0.23 | 0.24 | 0.32 | 0.23 | 0.31 | 0.23 | 0.29 | 0.35 |

### Examples 22-30

Ex 22-30 were made according to the general procedure without any resin and with Acrylic 1 and the specific plasticizer as shown in Tables 4, 5, and 6 except that Ex 22-24 were air dried at rt for 3 d. The weights of the components are displayed as parts by weight of the acrylic solids. Comp Ex C1 was made according to the general procedure using Acrylic 1 without any plasticizer or resin.

The results show that the plasticizers lower the temperature of the maximum tan δ peak. The shift is determined by the amount of plasticizer. Pz 1 increases the tan δ peak height. Pz 2 lowers the tan δ peak height and Pz 3 does not change the tan δ peak height. The increase or decrease is determined by the amount of plasticizer. The plasticizers cause the sample surface to be tacky.

TABLE 4
Acrylic 1, Pz 1-3 (10 phr), and No Resin

| | | | |
|---|---|---|---|
| Comp | | | |
| Ex C1 | Ex 22 | Ex 23 | Ex 24 |

Pz (phr)

| | | |
|---|---|---|
| Pz 1 | Pz 2 | Pz 3 |
| (10) | (10) | (10) |

Acrylic 1 (phr)

| | | | | |
|---|---|---|---|---|
| Temp | 100 | 100 | 100 | 100 |

| | |
|---|---|
| (° C.) | tan δ |

| | | | | | |
|---|---|---|---|---|---|
| | −50 | 0.06 | 0.06 | 0.07 | 0.08 |
| | −40 | 0.07 | 0.08 | 0.11 | 0.12 |
| | −30 | 0.08 | 0.18 | 0.23 | 0.21 |
| | −20 | 0.13 | 0.47 | 0.43 | 0.45 |
| | −10 | 0.29 | 0.96 | 0.65 | 0.68 |
| | 0 | 0.39 | 1.40 | 1.15 | 1.27 |
| | 5 | 0.44 | — | — | — |
| | 10 | 0.56 | 1.22 | 1.49 | 1.52 |
| | 15 | 0.81 | — | — | — |
| | 20 | 1.21 | 1.07 | 1.14 | 1.11 |
| | 25 | 1.56 | 1.04 | 1.02 | 0.99 |
| | 30 | 1.50 | 1.02 | 0.95 | 0.94 |
| | 40 | 1.09 | 1.07 | 0.96 | 0.98 |
| | 50 | 0.94 | 1.25 | 1.07 | 1.14 |
| | 60 | 0.98 | 1.48 | 1.25 | 1.38 |
| | 70 | 1.14 | 1.73 | 1.45 | — |
| Tacky | | No | Yes | yes | yes |
| sample | | | | | |
| surface? | | | | | |

TABLE 5
Acrylic 1, Pz 1-3 (10 pph), and No Resin.

| | | | |
|---|---|---|---|
| Comp | | | |
| Ex C1 | Ex 25 | Ex 26 | Ex 27 |

Pz (pphr)

| | | |
|---|---|---|
| Pz 1 | Pz 2 | Pz 3 |
| (10) | (10) | (10) |

Acrylic 1 (phr)

| | | | | |
|---|---|---|---|---|
| Temp | 100 | 100 | 100 | 100 |

| | |
|---|---|
| (° C.) | tan δ |

| | | | | | |
|---|---|---|---|---|---|
| | −50 | 0.06 | 0.06 | 0.07 | 0.07 |
| | −40 | 0.07 | 0.08 | 0.11 | 0.10 |
| | −30 | 0.08 | 0.14 | 0.22 | 0.18 |
| | −20 | 0.13 | 0.31 | 0.44 | 0.39 |
| | −10 | 0.29 | 0.52 | 0.80 | 0.56 |
| | 0 | 0.39 | 0.89 | 1.38 | 1.05 |
| | 5 | 0.44 | 1.27 | 1.49 | 1.40 |
| | 10 | 0.56 | 1.61 | 1.37 | 1.51 |
| | 15 | 0.81 | 1.57 | 1.20 | 1.39 |
| | 20 | 1.21 | 1.30 | 1.08 | 1.21 |
| | 25 | 1.56 | 1.10 | 1.02 | 1.05 |
| | 30 | 1.50 | 0.98 | 0.99 | 0.96 |
| | 40 | 1.09 | 0.95 | 1.05 | 0.95 |
| | 50 | 0.94 | 1.06 | 1.21 | 1.08 |
| | 60 | 0.98 | — | 1.43 | 1.29 |
| | 70 | 1.14 | — | — | — |
| Tacky sample | | No | — | — | — |
| surface? | | | | | |

TABLE 6
Acrylic 1, Pz 1-3 (5 phr), and No Resin.

| | | | |
|---|---|---|---|
| Comp | | | |
| Ex 1 | Ex 28 | Ex 29 | Ex 30 |

Pz (phr)

| | | | |
|---|---|---|---|
| — | Pz 1 (5) | Pz 2 (5) | Pz 3 (5) |

Acrylic 1 (phr)

| | | | | |
|---|---|---|---|---|
| Temp | 100 | 100 | 100 | 100 |

| | |
|---|---|
| (° C.) | tan δ |

| | | | | |
|---|---|---|---|---|
| −50 | 0.06 | 0.05 | 0.06 | 0.07 |
| −40 | 0.07 | 0.07 | 0.08 | 0.08 |
| −30 | 0.08 | 0.10 | 0.14 | 0.12 |
| −20 | 0.13 | 0.21 | 0.29 | 0.25 |
| −10 | 0.29 | 0.38 | 0.46 | 0.42 |
| 0 | 0.39 | 0.49 | 0.74 | 0.59 |
| 10 | 0.56 | 1.01 | 1.32 | 1.22 |
| 15 | 0.81 | 1.45 | 1.45 | 1.57 |
| 20 | 1.21 | 1.66 | 1.37 | 1.54 |
| 25 | 1.56 | 1.45 | 1.21 | 1.31 |
| 30 | 1.50 | 1.18 | 1.08 | 1.11 |
| 40 | 1.09 | 0.95 | 0.97 | 0.93 |
| 50 | 0.94 | 0.95 | 1.01 | 0.96 |
| 60 | 0.98 | 1.08 | 1.17 | 1.11 |
| 70 | 1.14 | 1.30 | | 1.33 |

### Examples 15-21 and Comparative Example C3

Ex 15 was made according to the general procedure without any plasticizer and with Acrylic 3 and the specific resin as shown in Table 7. The weights of the components are displayed as parts by weight of the acrylic solids. Ex 16-21 were made according to the general procedure using Acrylic 3 and Resin R2 and the amount and type of plasticizer as shown in Table 7. Comp Ex C3 was made according to the general procedure using Acrylic 3 without any plasticizer or resin.

The results show that the Comp Ex C3 provides a maximum tan δ peak outside the temperature range of interest (0-40° C.). Blending Acrylic 3 with Resin R2 will increase the tan δ peak height, and will slightly increase the tan δ peak temperature. Blending the Acrylic 3 with Resin R2 and Pz 1-3 will increase the tan δ peak height, and will lower the tan δ peak temperature to the temperature range of interest. A higher plasticizer addition results in a lower tan δ peak temperature. Pz 1 and Pz 2 slightly lower the tan δ peak height at the higher addition level. Pz 3 greatly lowers the tan δ peak height at the higher addition level.

TABLE 7
Acrylic 3, Resin R2, and Pz 1-3.

| | Temp | Comp | | | | | | | |
|---|---|---|---|---|---|---|---|---|---|
| | (° C.) | Ex C3 | Ex 15 | Ex 16 | Ex 17 | Ex 18 | Ex 19 | Ex 20 | Ex 21 |
| Pz (phr) | | | | Pz 1 (2.5) | Pz 1 (15) | Pz 2 (2.5) | Pz 2 (15) | Pz 3 (2.5) | Pz 3 (15) |
| Resin R2 (phr) | | | 20 | 20 | 20 | 20 | 20 | 20 | 20 |
| Acrylic 3 (phr) | | 100 | 100 | 100 | 100 | 100 | 100 | 100 | 100 |
| | | tan δ | | | | | | | |
| | −30 | 0.03 | 0.04 | 0.03 | 0.06 | 0.04 | 0.08 | 0.04 | 0.07 |
| | −20 | 0.04 | 0.06 | 0.04 | 0.08 | 0.04 | 0.13 | 0.04 | 0.09 |
| | −10 | 0.04 | 0.07 | 0.05 | 0.12 | 0.05 | 0.20 | 0.05 | 0.15 |
| | 0 | 0.06 | 0.09 | 0.07 | 0.23 | 0.07 | 0.42 | 0.07 | 0.34 |
| | 10 | 0.09 | 0.14 | 0.11 | 0.78 | 0.12 | 1.27 | 0.12 | 1.18 |
| | 20 | 0.17 | 0.23 | 0.23 | 2.72 | 0.28 | 2.53 | 0.28 | 1.60 |
| | 30 | 0.50 | 0.48 | 0.89 | 1.84 | 1.00 | 1.35 | 1.25 | 1.29 |
| | 40 | 2.55 | 2.32 | 2.85 | 0.92 | 2.70 | 0.75 | 2.65 | 0.90 |
| | 45 | 2.15 | 2.85 | 2.27 | 0.71 | 2.12 | 0.59 | 2.06 | 0.67 |
| | 50 | 1.46 | 1.99 | 1.50 | 0.56 | 1.43 | 0.48 | 1.41 | 0.52 |
| | 60 | 0.78 | 0.96 | 0.79 | 0.39 | 0.77 | 0.36 | 0.77 | 0.38 |
| | 70 | 0.47 | 0.57 | 0.49 | 0.33 | 0.48 | 0.33 | 0.48 | 0.35 |
| | 80 | 0.32 | 0.38 | 0.35 | 0.34 | 0.35 | | 0.35 | 0.37 |

Other embodiments will be apparent to those skilled in the art from consideration of the specification and practice of the embodiments disclosed herein. It will be understood that variations and modifications can be effected within the spirit and scope of the disclosed embodiments. It is further intended that the specification and examples be considered as exemplary only, with a true scope and spirit of the disclosed embodiments being indicated by the following.

1. An acrylic coating composition comprising:
(a) an acrylic polymer component;
(b) a resin; and
(c) a plasticizer,
wherein the resin is present in the composition from about 0 to about 40 phr relative to the sum total of the acrylic polymer component, and
wherein the plasticizer is present in the composition from about 0 to about 15 phr relative to the sum total of the acrylic polymer component,
wherein the total amount of resin and plasticizer is at least 2 phr relative to the sum total of the acrylic polymer component.

2. The composition of claim 1, wherein the plasticizer is present in the composition at 0 phr relative to the sum total of the acrylic polymer component; and the resin is present in the composition from about 2 to about 40 phr.

3. The composition of claim 1, wherein the plasticizer is present in the composition from about 2 to 10 phr relative to the sum total of the acrylic polymer component; and the resin is present in the composition at 0 phr.

4. The composition of claim 1, wherein the plasticizer is present in the composition from about 1 to about 5 phr relative to the sum total of the acrylic polymer component, and the resin is present in the composition at less than about 20 phr relative to the sum total of the acrylic polymer component.

5. The composition of claim 1, wherein the plasticizer is chosen from orthophthalates; terephthalates; isophthalates; trimellitates; adipates; cyclohexanedicarboxylates; benzoates; phosphates; diesters of ethylene glycol, propylene glycol, their oligomers, or mixtures thereof; citrates; succinates; alkyl sulfonates; fatty acid esters and epoxidized fatty acid esters, optionally substituted; triglycerides and epoxidized triglycerides, optionally substituted; dianhydrohexitol diesters; pentaerythritol-based tetraesters; furan-based esters; glycerol esters; other esters; ketals; and/or polymeric plasticizers.

6. The composition of claim 5, wherein the plasticizer is chosen from terephthalates, benzoates, or glycerol esters.

7. The composition of claim 6, wherein the plasticizer is chosen from diethylene glycol dibenzoate, dipropylene glycol dibenzoate, triethylene glycol dibenzoate, bis-n-butyl terephthalate, or 1,2,3-triacetoxypropane.

8. The composition of claim 1, wherein the resin comprises unhydrogenated or hydrogenated rosin esters, unhydrogenated or hydrogenated rosin acids, aromatic modified hydrocarbon resins, or aliphatic hydrocarbon resins.

9. The composition of claim 8, wherein the resin comprises rosin glycerol esters, hydrogenated rosin pentaerythritol esters, or aromatic-modified C5 hydrocarbon resin.

10. The composition of claim 1, wherein the acrylic polymer component comprises an acrylic polymer chosen from a methacrylic ester-acrylic ester copolymer or an acrylic ester-styrene copolymer.

11. The composition of claim 1, further comprising other components chosen from fillers, pigments, stabilizers, foaming agents, hollow materials, surfactants, coalescing aids, defoamers, biocides, rheology control additives, or adhesion promoters.

12. The composition of claim 1, wherein the fillers comprise calcium carbonate, magnesium carbonate, silica, clay, mica, graphite, or zinc oxide.

13. The composition of claim 11, wherein the adhesive promoters comprise polyamidoamines, blocked isocyanates and isocyanurates, or silanes.

14. The composition of claim 1, wherein the dried composition has a maximum Tan Delta (Tan δₘₐₓ) occurring at a temperature range of between −20° C. to 70° C. and wherein the Tan δₘₐₓ ranges from 1.0 to 5.0, when measured on a circular sample of 8 mm diameter and nominally 1-2 mm thickness using a Dynamic Mechanical Analyzer with 8 mm stainless steel parallel plates at an automatic strain adjustment from 0.1% to 15% and at a frequency of 1 Hz and a temperature ramp rate of 5° C./min.

15. A method of improving vibration damping of a substrate comprising affixing the composition of claim 1 onto the substrate.

16. The method of claim 15, wherein the affixing comprises
(a) applying the composition onto the substrate;
(b) drying the composition to produce an acrylic-coated substrate; and
(c) cooling the acrylic-coated substrate to ambient temperature.

17. The method of claim 16, wherein the applying of the composition onto the substrate comprises coating the substrate with the composition.

18. The method of claim 15, wherein the affixing comprises
(a) fusing the composition into a sheet; and
(b) adhering the sheet to the substrate.

19. The method of claim 16, wherein the drying occurs at a temperature range from 20° C. to 175° C. for a time period ranging from 1 minute to 24 hours.

20. The method of claim 15, wherein the substrate is part of a wheeled vehicle.
